(19) United States
(12) Patent Application Publication
(10) Pub. No.: US 2015/0243992 A1
(43) Pub. Date: Aug. 27, 2015

(54) SECONDARY BATTERY AND METHOD FOR PRODUCING SECONDARY BATTERY

(71) Applicants: Murata Manufacturing Co., Ltd., Nagaokakyo-shi (JP); Carlit Holdings co., Ltd., Tokyo (JP)

(72) Inventors: Norihiko Maruyama, Nagaokakyo-shi (JP); Masaharu Sato, Nagaokakyo-shi (JP); Eiji Kokubu, Shibukawa-shi (JP); Kazumi Chiba, Tokyo (JP); Kazato Yanada, Shibukawa-shi (JP); Toshiyuki Kiryu, Shibukawa-shi (JP); Teruhisa Takada, Shibukawa-shi (JP); Hidehisa Mokudai, Wako-shi (JP); Toru Sukigara, Wako-shi (JP)

(21) Appl. No.: 14/707,314

(22) Filed: May 8, 2015

Related U.S. Application Data
(63) Continuation of application No. PCT/JP2013/079999, filed on Nov. 6, 2013.

(30) Foreign Application Priority Data
Nov. 9, 2012 (JP) 2012-247700

(51) Int. Cl. H01M 4/60; H01M 10/052; H01M 4/04; H01M 10/05

(52) U.S. Cl. CPC H01M 4/60; H01M 10/05; H01M 10/052; H01M 4/0404; H01M 2220/30

(57) ABSTRACT

A secondary battery that includes a positive electrode active material layer, which is mainly composed of an organic compound having a multi-electron system, on a surface of a positive electrode current collector. The surface of the positive electrode active material layer is covered by an ion-conducting thin film that selectively transmits lithium ions. A positive electrode is composed of the positive electrode current collector, the positive electrode active material layer, and the ion-conducting thin film.

### CROSS REFERENCE TO RELATED APPLICATIONS

This application is a continuation application of international patent application Serial No. PCT/JP2013/079999 filed 6 Nov. 2013, which published as PCT Publication No. WO2014/073561 on 15 May 2014, which claims benefit of Japan patent application No. 2012-247700 filed 9 Nov. 2012, the entire content of which are incorporated herein by reference.

### FIELD OF THE INVENTION

The present invention relates to a secondary battery and a method for producing a secondary battery, and more particularly relates to a secondary battery which has an electrode active material mainly composed of a multi-electron organic compound and repeats charge and discharge by using a battery electrode reaction of the electrode active material, and a method for producing the secondary battery.

### BACKGROUND OF THE INVENTION

With the market expansion of mobile electronic devices such as cellular phones, laptop personal computers and digital cameras, a long-life secondary battery having high energy density is growingly developed as a cordless power source of these electronic devices.

An electrode active material of structural elements of the secondary battery is a substance directly contributing to electrode reactions of a charge reaction and a discharge reaction in the battery, and has a central role in the secondary battery. That is, the electrode reaction in the battery is a reaction which occurs associated with giving and receiving of electrons by applying a voltage to an electrode active material electrically connected to an electrode located in an electrolyte, and the electrode reaction progresses during charge and discharge of the battery. Accordingly, as described above, the electrode active material systemically has a central role in the secondary battery.

In recent years, organic materials having an oxidation-reduction activity receive attention as this kind of a material for an electrode active material. In the organic materials, it is thought that a secondary battery having a larger capacity density than inorganic materials will be able to be achieved because multi-electrons of two or more electrons can be involved in the oxidation-reduction reaction, by using such a characteristic for an electrode reaction in the battery.

For example, the document 1 proposes a nonaqueous solution based battery which includes an electrode containing an active material capable of occluding/releasing lithium ions as a negative electrode and includes, as a positive electrode, an electrode for a battery which has a structural unit represented by the following general formula (1′) or the following general formula (2′):

—(NH—CS—CS—NH) (1′),

R¹—(NH—CS—CS—NH)ₙ—R² (2′),

and includes a rubeanic acid or rubeanic acid polymer capable of being coupled with lithium ions.

In the above general formula (2′), R¹ and R² represent a hydrogen atom, a halogen atom, an alkyl group having 1-3 carbon atoms, an amino group, a hydroxyl group or a sulfone group and n represents an integer of 1-20.

FIG. 1 is a sectional view schematically showing a structure of a nonaqueous solution battery described in the document 1.

In the nonaqueous solution battery, a positive electrode active material layer 102 containing active material particles 102a composed of a rubeanic acid or rubeanic acid polymer as the main component thereof is formed on the surface of a positive electrode current collector 101 made of an aluminum foil or the like, and the positive electrode current collector 101 and the positive electrode active material layer 102 constitute a positive electrode 103. A negative electrode 104 is placed on a side opposite to the positive electrode 103. This negative electrode 104 includes a negative electrode current collector 106 made of copper or the like and a negative electrode active material layer 106 containing metal lithium, which is formed on the surface of the negative electrode current collector 105 so as to be opposed to the positive electrode active material layer 102.

Moreover, a separator 107 composed of a gelated or a solid electrolyte is interposed between the positive electrode active material layer 102a and the negative electrode active material layer 105, and further an electrolyte solution or electrolytic solution 108 formed by dissolving an electrolyte salt in a solvent is filled into a battery case.

In the document 1, the rubeanic acid or rubeanic acid polymer containing a dithione structure represented by the general formula (1′) or (2′) is coupled with lithium ions during reduction, and releases the coupled lithium ions during oxidation. It is possible to perform charge and discharge by using such a reversible oxidation-reduction reaction of a rubeanic acid or rubeanic acid polymer.

Moreover, the document 1 describes that a solid electrolyte, in which an electrolyte salt is contained in a gelated material or a solid material (hereinafter, referred to as “a solid material and the like”), may be used in place of the electrolyte solution.

The document 2 proposes a battery including a positive electrode, a negative electrode, and an electrolytic solution containing an electrolyte and interposed between the positive electrode and the negative electrode, wherein the positive electrode contains a rubeanic acid or a rubeanic acid derivative as an active material and the molar concentration of the electrolyte in the electrolytic solution is set higher than 1.0 mol/L.

The battery described in the document 2 has a structure similar to that of the document 1.

The document 2 aims to achieve a high capacity density of charge and discharge by increasing an electrolyte salt concentration in the electrolyte solution to increase a molar quantity of anion derived from the electrolyte salt.

The document 1: JP No. 2008-147015A (claim 4, pars. [0011] and [0013], FIGS. 3 and 5)

The document 2: JP No. 2012-164480A (claim 1, pars. [0008] and [0028])

In the above-mentioned secondary battery, giving and receiving of electrons is performed through lithium ions between the positive electrode and the negative electrode, and therefore, it is important that lithium ions can be freely moved to a negative electrode during charge and can be freely moved to a positive electrode during discharge.

However, in the document 1 or 2, although the gelated material or the solid material is used for the separator 107, the electrolyte solution 108 is in contact with the surface of the positive electrode active material layer 102, and therefore there is a fear that the active material particles 102a in the positive electrode active material layer 102 may be eluted in the electrolyte solution 108. Particularly, in the secondary battery using an organic compound for the positive electrode active material, charging and discharging is performed by using an oxidation-reduction reaction of a molecule itself, and therefore the active material particle 102a is easily dissolved in the electrolyte solution 108 in contrast to a lithium ion secondary battery performing charging and discharging in a state of maintaining a crystal system.

Thus, when the active material particle 102a is dissolved in the electrolyte solution 108, the electrolyte solution 108 is contaminated, resulting in a reduction of migration efficiency of the lithium ions, and sufficient giving and receiving of electrons cannot be performed inside the positive electrode or at the surface of the positive electrode, resulting in deterioration of the charge-discharge efficiency, and there is a possibility that the battery capacity may be reduced.

Further, although the document 1 describes that a solid electrolyte may be used in place of the electrolyte solution 108, a concrete technique is not referred to. In this case, it is difficult to allow lithium ions to reach the inside of the positive electrode active material layer 102 by only bringing the solid electrolyte into contact with the positive electrode active material layer 102. That is, a conductive aid such as carbon black and a binder in addition to the active material particles 102a are contained in the positive electrode active material layer 102, and the positive electrode active material layer 102 forms a current collector having a concavo-convex shape which is greatly-complicated at a microscopic level and having a thickness of several tens of micrometer (μm). Therefore, by only bringing the solid electrolyte into contact with the positive electrode active material layer 102, even though a surface area of the positive electrode active material layer 102 is increased, lithium ions having moved from a negative electrode 106 can perform giving and receiving of lithium ions at only a contact part with the solid electrolyte and it is difficult to allow lithium ions to reach the inside of the positive electrode active material layer 102, and therefore there is a fear of causing efficiency of ionic conduction to be significantly deteriorated.

Furthermore, to obtain a desired ion conductive property, the solid electrolyte needs to be used in conjunction with the electrolyte solution to reduce a proportion of the solid electrolyte to be used as far as possible because the solid electrolyte currently put to practical use is lower in ion conductive property than the liquid electrolyte solution, and therefore there is a fear of causing a complicated battery constitution.

The present invention was made in view of such circumstances, it is an object of the present invention to provide a secondary battery which enables a desired battery capacity to be obtained by improving charge-discharge efficiency and a method for producing a secondary battery.

### SUMMARY OF THE INVENTION

In order to achieve the above-mentioned objective, the secondary battery according to the present invention is characterized by a secondary battery including a first electrode, a second electrode and an electrolyte interposed therebetween and containing lithium in at least any one of the first electrode, the second electrode and the electrolyte, wherein one electrode of the first electrode and the second electrode includes an electrode active material layer containing, as the main component thereof, a multi-electron organic compound which has two or more electrons to be involved in a battery electrode reaction, and at least the surface of the electrode active material layer is coated with an ion conductor thin film selectively transmitting lithium.

According to the secondary battery of the present invention, elution of the electrode active material in the electrolyte does not occur, and organic molecules or other ions do not reach the surface and inside of the electrode active material layer and only lithium ions reach the surface and inside of the electrode active material layer smoothly. Thereby, the efficiency of ionic conduction is improved, and therefore a reduction of a discharge capacity can be suppressed and a secondary battery having high charge-discharge efficiency and a desired battery capacity can be attained.

Moreover, the electrode active material contains the organic compound as the main component thereof, and therefore the resulting secondary battery is a secondary battery in which an environmental burden is low and its safety is taken into consideration.

Further, in the secondary battery of the present invention, the ion conductor thin film preferably contains at least one selected from the group consisting of polyvinylidene fluoride, polymethacrylate and a polymer of tripropylene glycol diacrylate.

furthermore, in the secondary battery of the present invention, the organic compound preferably contains, in structural unit thereof, at least one selected from the group consisting of dithione compounds having a dithione structure, dione compounds having a dione structure, and diamine compounds having a diamine structure.

Then, in the secondary battery of the present invention, the dithione compound is preferably represented by the general formula:

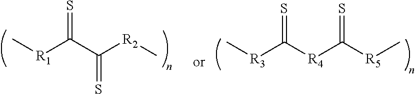

In the above general formulas, n is an integer of 1 or more, R₁ to R₃ and R₅ represent any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₁ to R₃ and R₅ include the case in which they are the same and the case in which they are linked with one another to form a saturated or unsaturated cyclic structure. Further, R₄ represents at least one of a substituted or unsubstituted alkylene group, a substituted or unsubstituted arylene group and a substituted or unsubstituted imino group, and it includes the case in which the imino groups are linked with each other.

Further, in the secondary battery of the present invention, the dione compound is preferably represented by the general formula:

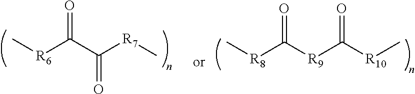

In the above general formulas, n is an integer of 1 or more, R₆ to R₈ and R₁₀ represent any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₆ to R₈ and R₁₀ include the case in which they are the same and the case in which they are linked with one another to form a saturated or unsaturated cyclic structure. Further, R₉ represents at least one of a substituted or unsubstituted alkylene group, a substituted or unsubstituted arylene group and a substituted or unsubstituted imino group, and it includes the case in which the imino groups are linked with each other.

Further, in the secondary battery of the present invention, the diamine compound is preferably represented by the general formula:

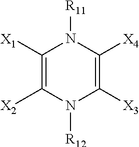

In the above formula, R₁₁ and R₁₂ represent any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amino group, a substituted or unsubstituted amide group, a substituted or unsubstituted sulfone group, a substituted or unsubstituted thiosulfonyl group, a substituted or unsubstituted sulfonamide group, a substituted or unsubstituted imino group, a substituted or unsubstituted azo group, and linking groups composed of combination of one or more thereof. X₁ to X₄ represent at least one of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted aryl group, a substituted or unsubstituted aromatic heterocyclic group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group and a substituted or unsubstituted acyloxy group, and these substituents include the case of forming a cyclic structure therebetween.

Further, in the secondary battery of the present invention, the electrode active material is preferably contained in any one of a reaction starting material, a reaction product and an intermediate product in at least a discharge reaction of the electrode reaction in the battery.

Further, a method for producing a secondary battery according to the present invention is characterized by a method for producing a secondary battery including a first electrode, a second electrode and an electrolyte interposed therebetween, wherein one electrode of the first electrode and the second electrode is formed so as to include an electrode active material layer containing a multi-electron organic compound as the main component thereof and at least the surface of the electrode active material layer is coated with an ion conductor thin film selectively transmitting lithium ions.

According to the method for producing a secondary battery of the present invention, a secondary battery having high charge-discharge efficiency and a desired battery capacity can be easily prepared.

The above and other objects, features, and advantages of the invention will become more apparent from the following description.

### BRIEF EXPLANATION OF THE DRAWINGS

FIG. 1 is a sectional view schematically showing a conventional example of a secondary battery.

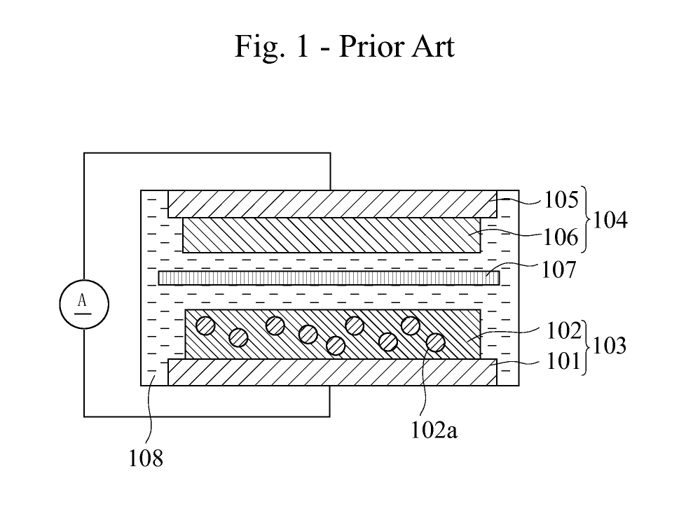

FIG. 2 is a sectional view schematically showing an embodiment of a secondary battery according to the present invention.

FIG. 3 is a drawing showing a charge and discharge characteristic of the present example.

### DETAILED DESCRIPTION OF THE INVENTION

An embodiment of the present invention will be described in detail.

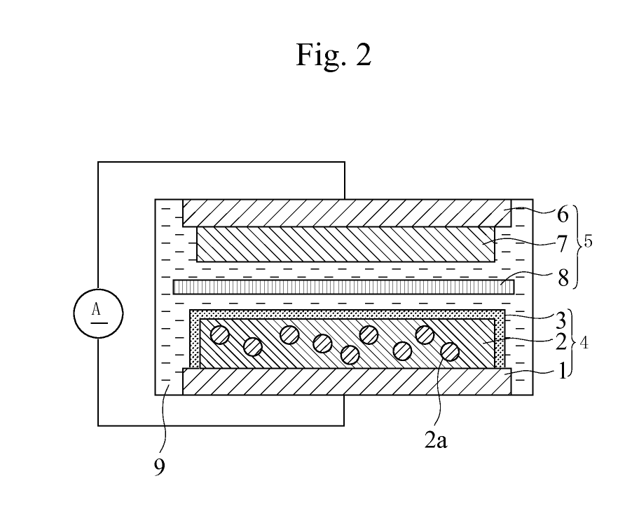

FIG. 2 is a sectional view schematically showing an embodiment of a secondary battery according to the present invention.

In this secondary battery, a positive electrode active material layer 2 containing a multi-electron organic compound as the main component is formed on the surface of a positive electrode current collector 1 made of an aluminum foil or the like, and further the surface of the positive electrode active material layer 2 is coated with anion conductor thin film 3 selectively transmitting lithium ions. The positive electrode current collector 1, the positive electrode active material layer 2, and the ion conductor thin film 3 constitute a positive electrode (first electrode) 4.

A negative electrode (second electrode) 5 is placed on a side opposite to the positive electrode 4. The negative electrode 5 includes a negative electrode current collector 6 made of copper or the like and a negative electrode active material layer 7 containing metal lithium, which is formed on the surface of the negative electrode current collector 6 so as to be opposed to the positive electrode active material layer 2.

Moreover, a separator 8 composed of a porous resin material or a gelated or a solid material is interposed between the positive electrode 4 and the negative electrode 5, and further an electrolyte solution 9 formed by dissolving an electrolyte salt in a solvent is filled into a battery case.

Further, the positive electrode active material layer 2 contains active material particles 2a composed of a multi-electron organic compound.

That is, in recent years, the electrode active materials containing the organic compound as a main component receive attention, and among these materials, multi-electron organic compound having two or more electrons to be involved in the battery electrode reaction, for example, dithione compounds, dione compounds and diamine compounds are promising material as an active material having high charge-discharge efficiency and capable of realizing a high capacity density.

Thus, in the present embodiment, the active material particle 2a composed of a multi-electron organic compound are used as the main component of the positive electrode active material layer 2.

As described in the above-mentioned background of the invention, when the above organic compound is used for the main component of the positive electrode active material layer 2, in the case of a low-molecular-weight organic compound, dissolution in an electrolyte solution 9 or contamination of the electrode due to the dissolved compound easily occurs, and therefore the battery lacks the stability for repeated charge and discharge. On the other hand, in the case of a polymer compound, interactions between molecules within the polymer compound is large, and therefore the movement of ions is interfered with and there is a fear that the proportion of the active material to be used effectively may be reduced.

When the solid electrolyte is used in place of the electrolyte solution, it is not possible to allow lithium ions from the negative electrode 5 to reach the inside of the positive electrode active material layer 2 by only bringing the solid electrolyte into contact with the positive electrode active material layer 2 because the positive electrode active material layer 2 contains a conductive aid and a binder in addition to the active material particles 2a as described later, and therefore the efficiency of ionic conduction is low, and furthermore there is a fear that charge-discharge efficiency may be lowered.

Thus, in the present embodiment, at least the surface of the positive electrode active material layer 2 is coated with the ion conductor thin film 3 selectively transmitting only lithium, and this make it possible for lithium ions from the negative electrode 5 to reach the positive electrode active material layer 2 effectively without causing the elution of the positive electrode active material layer 2 in the electrolyte solution 9 to improve the efficiency of ionic conduction. That is, by coating at least the surface of the positive electrode active material layer 2 with the ion conductor thin film 3, the charge-discharge efficiency is improved and the deterioration of a battery capacity is suppressed even in repeating charge and discharge.

Besides, the ion conductor thin film 3 only need to be able to prevent the elution of the positive electrode active material layer 2 in the electrolyte solution 9, and therefore the thickness is preferably as thin as possible and preferably about 5-10 μm.

Such an ion conductor thin film 3 is not particularly limited as long as it is a film which transmits only lithium ions with a small ion radius and does not transmit organic molecules, other ions and the like, and it is possible to use, for example, materials containing at least one selected from the group consisting of polyvinylidene fluoride, polymethacrylate and a polymer of tripropylene glycol diacrylate. By applying a solution for an ion-conducting film, which is prepared by dissolving these materials in an organic solvent, onto the surface of the positive electrode active material layer 2 and drying the solution, a desired ion conductor thin film 3 can be prepared.

Further, as described above, the positive electrode active material layer 2 contains the conductive aid and the binder in addition to the active material particles 2a.

The conductive aid is not particularly limited, and for example, carbonaceous fine particles such as graphite, carbon black, and acetylene black; carbon fibers such as vapor-grown carbon fibers, carbon nanotubes, and carbon nanohorns; and conductive polymers such as polyaniline, polypyrrole, polythiophene, polyacetylene, and polyacene can be used. Further, two or more kinds of the conductive materials can be mixed for use. In addition, the content of the conductive aid in the positive electrode active material layer 2 is preferably 10 to 80% by weight.

The binder is not particularly limited, and various resins such as polyethylene, polyvinylidene fluoride, polyhexafluoropropylene, polytetrafluoroethylene, polyethylene oxide, and carboxymethyl cellulose can be used.

Further, the electrolyte solution 9 is interposed between the positive electrode 4 and the negative electrode 5 and performs charge carrier transport between both electrodes, and as such an electrolyte solution 9, an electrolyte solution 9 having an ionic conduction of 10⁻⁵-10⁻¹ S/cm can be used and the electrolyte solution prepared by dissolving the electrolyte salt in an organic solvent.

As the electrolyte salt, for example, LiPF₆, LiClO₄, LiBF₄, LiCF₃SO₃, LiN(CF₃SO₂)₂, LiN(C₂F₅SO₂)₂, LiC(CF₃SO₂)₃, LiC(C₂F₅SO₂)₃ and the like can be used.

As the organic solvent, ethylene carbonate, propylene carbonate, dimethyl carbonate, diethyl carbonate, methyl ethyl carbonate, γ-butyrolactone, tetrahydrofuran, dioxolane, sulfolane, dimethylformamide, dimethylacetamide, or 1-methyl-2-pyrrolidone can be used.

Next, of the active material particles 2a—i.e. the organic compounds—predominantly constituting the positive electrode active material layer 2, dithione compounds, dione compounds and diamine compounds, which are particularly expected of practical realization, will be described in detail.

(1) Dithione Compound

In the dithione compound, the stability during charge and discharge (an oxidized state and a reduced state) is excellent, and multi-electron reaction of two-electrons or more can occur in the oxidation-reduction reaction. Further, when the surface of the positive electrode active material layer 2 is coated with the ion conductor thin film 3, charge-discharge efficiency is improved, and therefore charge and discharge of a multi-electron reaction can be stably repeated and it becomes possible to obtain a secondary battery having a high capacity density.

Although such a dithione compound is not particularly limited as long as it has a dithione structure in structural unit thereof, a compound represented by the following general formula (1) or (2) can be preferably used.

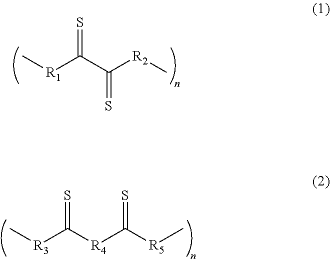

In the above general formula (1) or (2), n is an integer of 1 or more, R₁ to R₃ and R₅ represent any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₁ to R₃ and R₅ include the case in which they are the same and the case in which they are linked with one another to form a saturated or unsaturated cyclic structure. Further, R₄ represents at least one of a substituted or unsubstituted alkylene group, a substituted or unsubstituted arylene group and a substituted or unsubstituted imino group, and it includes the case in which the imino groups are linked with each other.

Dithione compounds falling within the category of the compounds represented by the general formula (1) may include organic compounds represented by the following chemical formulas (1a)-(1i).

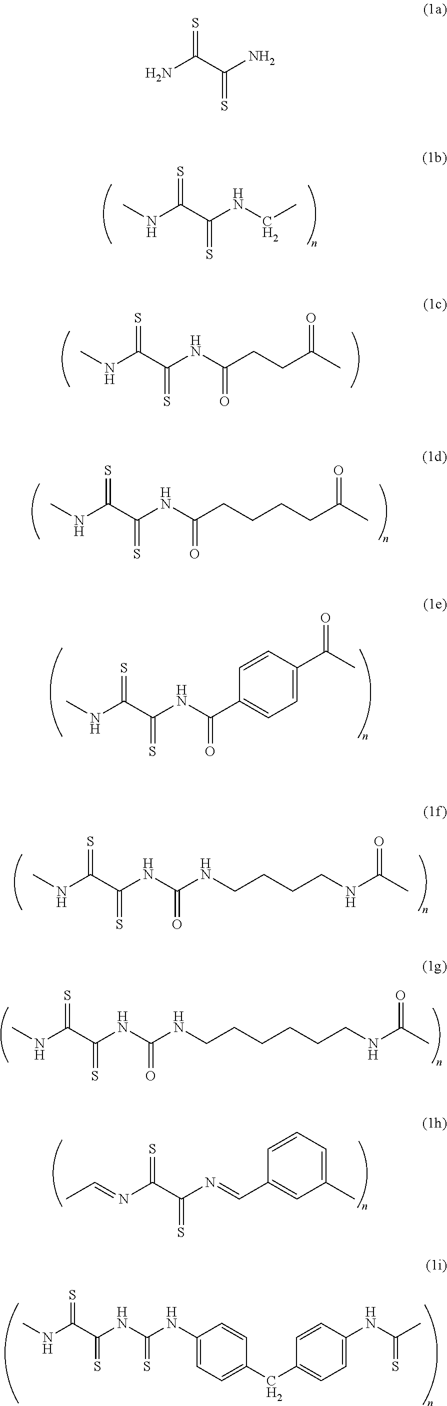

The following chemical reaction formula (I) shows an example of the charge-discharge reaction which is predicted when the dithione compound represented by the chemical formula (1a) is used for the main component of the positive electrode active material layer 2 and Li is used for a cation of an electrolyte salt.

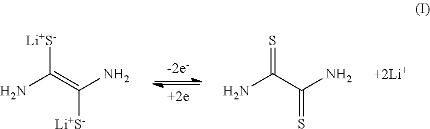

Further, dithione compounds falling within the category of the compounds represented by the general formula (2) may include organic compounds represented by the following chemical formulas (2a)-(2g).

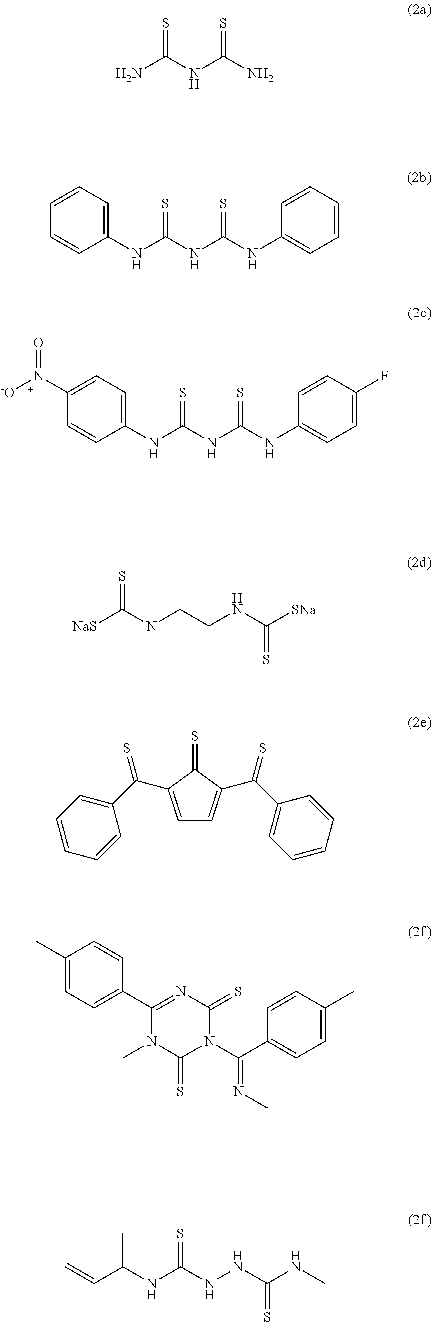

The following chemical reaction formula (II) shows an example of the charge-discharge reaction which is predicted when the dithione compound represented by the chemical formula (2a) is used for the main component of the positive electrode active material layer 2 and Li is used for a cation of an electrolyte salt.

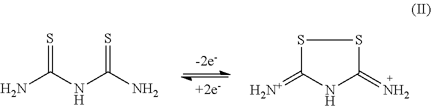 [SMILES: NC(=S)NC(N)=S ; N=c1[nH]c(=[NH2+])ss1]

Besides, although molecular weight of the dithione compound is not particularly limited, a molecular weight is increased and therefore an electric storage capacity per unit mass—i.e. a capacity density—is reduced when a portion other than a dithione structure is large. Accordingly, the molecular weight of a portion other than the dithione structure is preferably small.

(2) Dione Compound

In the dione compound, the stability during charge and discharge (an oxidized state and a reduced state) is excellent as with the dithione compound, and multi-electron reaction of two-electrons or more can occur in the oxidation-reduction reaction. Further, when the surface of the positive electrode active material layer 2 is coated with the ion conductor thin film 3, charge-discharge efficiency is improved, and therefore charge and discharge of a multi-electron reaction can be stably repeated and it becomes possible to obtain a secondary battery having a high capacity density.

Although such a dione compound is not particularly limited as long as it has a dione structure in structural unit thereof, a compound represented by the following general formula (3) or (4) can be preferably used.

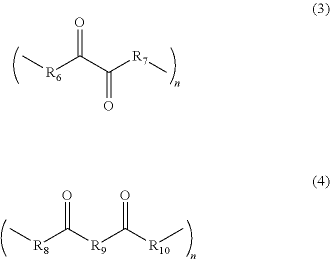

In the above general formula (3) or (4), n is an integer of 1 or more, R₆ to R₈ and R₁₀ represent any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof, and these R₆ to R₈ and R₁₀ include the case in which they are the same and the case in which they are linked with one another to forma saturated or unsaturated cyclic structure. Further, R₉ represents at least one of a substituted or unsubstituted alkylene group, a substituted or unsubstituted arylene group and a substituted or unsubstituted imino group, and it includes the case in which the imino groups are linked with each other.

Dione compounds falling within the category of the compounds represented by the general formula (3) may include organic compounds represented by the following chemical formulas (3a)-(3e).

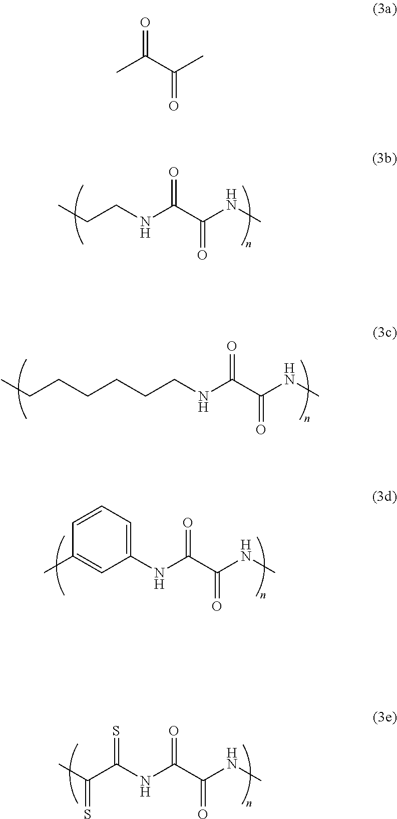

The following chemical reaction formula (III) shows an example of the charge-discharge reaction which is predicted when the dione compound represented by the chemical formula (3a) is used for the main component of the positive electrode active material layer 2 and Li is used for a cation of an electrolyte salt.

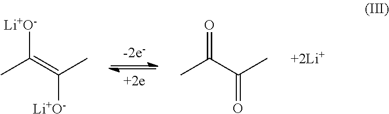

Dione compounds falling within the category of the compounds represented by the general formula (4) may include organic compounds represented by the following chemical formulas (4a)-(4f).

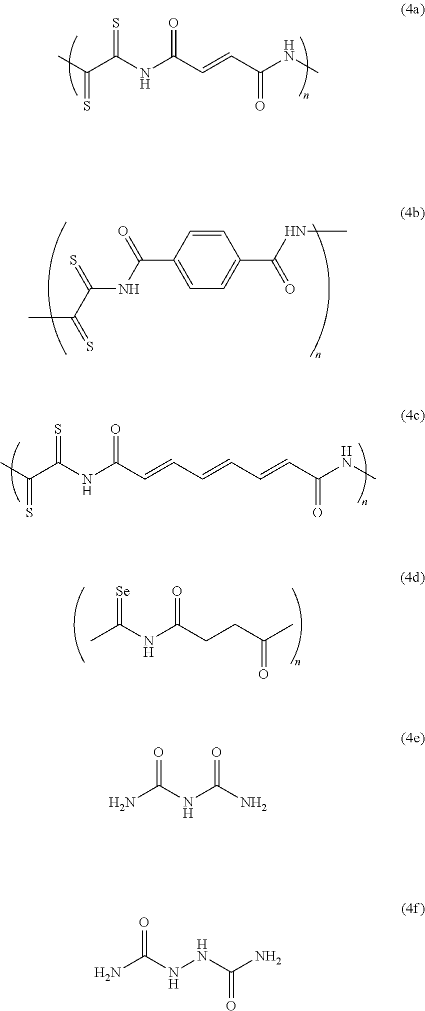

The following chemical reaction formula (IV) shows an example of the charge-discharge reaction which is predicted when the dione compound represented by the chemical formula (4a) is used for the main component of the positive electrode active material layer 2 and Li is used for a cation of an electrolyte salt.

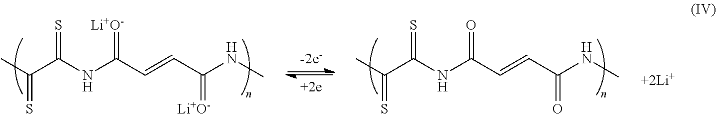

Although the molecular weight of the dione compound is not particularly limited, a molecular weight is increased and therefore an electric storage capacity per unit mass—i.e. a capacity density—is reduced when a portion other than a dione structure is large. Accordingly, the molecular weight of a portion other than the dione structure is preferably small.

Diamine Compound

In the diamine compound, the stability during charge and discharge (an oxidized state and a reduced state) is excellent as with the dithione compound and dione compound, and multi-electron reaction of two-electrons or more can occur in the oxidation-reduction reaction. Further, when the surface of the positive electrode active material layer 2 is coated with the ion conductor thin film 3, charge-discharge efficiency is improved, and therefore charge and discharge of a multi-electron reaction can be stably repeated and it becomes possible to obtain a secondary battery having a high capacity density.

Although such a diamine compound is not particularly limited as long as it has a diamine structure in its structural unit, an organic compound represented by the following general formula (5) can be preferably used.

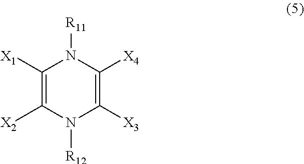

In the above general formula (5), R₁₁ and R₁₂ represent any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amino group, a substituted or unsubstituted amide group, a substituted or unsubstituted sulfone group, a substituted or unsubstituted thiosulfonyl group, a substituted or unsubstituted sulfonamide group, a substituted or unsubstituted imino group, a substituted or unsubstituted azo group, and linking groups composed of combination of one or more thereof. X₁ to X₄ represent at least one of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted aryl group, a substituted or unsubstituted aromatic heterocyclic group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group and a substituted or unsubstituted acyloxy group, and these substituents include the case of forming a cyclic structure therebetween.

As organic compounds falling within the category of the compounds represented by the general formula (5), organic compounds containing, in structural unit thereof, a phenazine structure in which aryl groups are coupled with each other with a pyrazine ring interposed therebetween, is more preferred, and for example, an organic compound represented by the chemical formulas (5a)-(5f) can be preferably used.

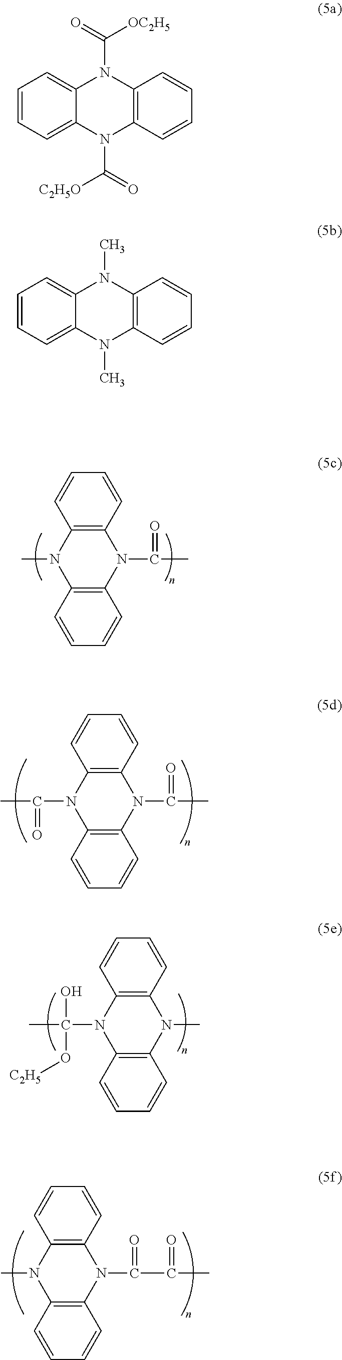

The following chemical reaction formula (V) shows an example of the charge-discharge reaction which is predicted when the organic compound represented by the chemical formula (5b) is used for the main component of the positive electrode active material layer 2 and Li is used for a cation of an electrolyte salt.

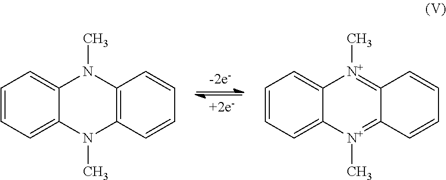 [SMILES: CN1c2ccccc2N(C)c2ccccc21 ; C[n+]1c2ccccc2[n+](C)c2ccccc21]

Although the molecular weight of the diamine compound is not particularly limited, a molecular weight is increased and therefore an electric storage capacity per unit mass—i.e. a capacity density—is reduced when a portion other than a diamine structure is large. Accordingly, the molecular weight of a portion other than the diamine structure is preferably small.

Besides, although the substituents listed above by the general formulas (1)-(5) are not particularly limited as long as they fall within the respective categories, it is preferred to select a desired substituent such that its molecular weight is about 250 because a charge amount capable of being stored per unit mass of the positive electrode active material is reduced when the molecular weights of the substituents are increased.

While the positive electrode active material has a varying structure and state depending on a charge state, a discharge state or an intermediate state thereof since the positive electrode active material is reversibly oxidized or reduced by charging and discharging, in the present embodiment, the positive electrode active material is contained in any one of a reaction starting material (a substance initiating a chemical reaction in an electrode reaction in the battery), a reaction product (a substance produced as a result of the chemical reaction), and an intermediate product in at least a discharge reaction, and thereby, it is possible to realize a secondary battery which has a positive electrode active material having high charge-discharge efficiency and a high capacity density.

Next, an example of a method for producing the secondary battery will be described in detail.

First, a positive electrode active material layer 2 is formed into an electrode shape. That is, preferably, any of the organic compounds described above is prepared. Then, the organic compound is mixed with the above-mentioned conductive material and binder, a solvent is then added to the resulting mixture to prepare a slurry for an active material, and the slurry for an active material is applied onto a positive electrode current collector 1 by an arbitrary coating method and dried to form a positive electrode active material layer 2 on the positive electrode current collector 1.

The solvent used for making the slurry for an active material is not particularly limited, and for example, basic solvents such as dimethylsulfoxide, dimethylformamide, N-methylpyrrolidone, propylene carbonate, diethyl carbonate, dimethyl carbonate and γ-butyrolactone; nonaqueous solvents such as acetonitrile, tetrahydrofuran, nitrobenzene and acetone; and protic solvents such as methanol and ethanol can be used.

Besides, a kind of the solvents, a mixing ratio of the organic compound and the solvent, and kinds and addition amounts of the conductive materials and the binders, and the like can be optionally set in consideration of required characteristics, productivity and the like of the secondary battery.

Next, a conductor solution formed by dissolving a conductor material such as polyvinylidene fluoride in an organic solvent is prepared. Then, the conductor solution is applied onto the whole surface of the positive electrode active material layer 2 and dried, and thereby, the surface of the positive electrode active material layer 2 is coated with an ion conductor in film 3 having a predetermined thickness (e.g., 5-10 μm) to form a positive electrode 4.

The solvent in which the conductor material is dissolved is not particularly limited and for example, the same solvent as that used in preparing the above-mentioned positive electrode active material layer 2 can be used.

Next, an electrolyte solution 9 is prepared. Then, the positive electrode 4 is impregnated with the electrolyte solution 9 to allow the electrolyte solution 9 to permeate the positive electrode 4, and thereafter, a separator 8 impregnated with the electrolyte solution 9 is laminated on the positive electrode 4, and a negative electrode active material 7 made of metal Li or the like and a negative electrode current collector 6 made of a copper foil or the like are laminated in turn, and thereafter, the electrolyte solution 9 is filled into an internal space. Thereafter, the resulting laminate is incorporated into a battery can (not shown) and the battery case is sealed to prepare a secondary battery.

As described above, according to the present embodiment, since the positive electrode 4 includes the positive electrode active material layer 2, as the main component thereof, a multi-electron organic compound which has two or more electrons to be involved in a battery electrode reaction and the surface of the positive electrode active material layer 2 is coated with the ion conductor thin film 3 selectively transmitting lithium, organic molecules or other ions do not reach the surface and inside of the positive electrode active material layer 2 and only lithium ions easily reach the surface and inside of the positive electrode active material layer 2. Thereby, the efficiency of ionic conduction is improved, and therefore a reduction of a discharge capacity can be suppressed and a secondary battery having high charge-discharge efficiency and a desired battery capacity can be attained.

Furthermore, the positive electrode active material layer 2 contains the organic compound as the main component, and therefore the resulting secondary battery is a secondary battery in which an environmental burden is low and its safety is taken into consideration.

Besides, the present invention is not limited to the above-mentioned embodiments, and various variations may be made without departing from the gist of the invention. For example, in the above embodiment, while the surface of the positive electrode active material layer 2 is coated with the ion conductor thin film 3, at least the surface of the positive electrode active material layer 2 has only to be coated with the ion conductor thin film 3, and therefore the whole surface of the positive electrode current collector 1 and the positive electrode active material layer 2 may be coated with the ion conductor thin film 3.

Further, in the above embodiment, a liquid electrolyte solution formed by dissolving an electrolyte salt in a solvent is used as an electrolyte, and furthermore, a solid electrolyte can also be used although it is inferior in ion conductivity to the electrolyte solution.

A polymer compound used for the solid electrolyte include vinylidene fluoride-based polymers such as polyvinylidene fluoride, vinylidene fluoride-hexafluoropropylene copolymer, vinylidene fluoride-ethylene copolymer, vinylidene fluoride-monofluoroethylene copolymer, vinylidene fluoride-trifluoroethylene copolymer, vinylidene fluoride-tetrafluoroethylene copolymer, and vinylidene fluoride-hexafluoropropylene-tetrafluoroethylene terpolymer; acrylonitrile-based polymers such as acrylonitrile-methylmethacrylate copolymer, acrylonitrile-methylacrylate copolymer, acrylonitrile-ethylmethacrylate copolymer, acrylonitrile-ethylacrylate copolymer, acrylonitrile-methacrylic acid copolymer, acrylonitrile-acrylic acid copolymer, and acrylonitrile-vinyl acetate copolymer; and polyethylene oxide, ethylene oxide-propylene oxide copolymer, and polymers of these acrylates and methacrylates.

Further, these polymer compounds gelated by containing an electrolyte solution or only polymer compounds containing an electrolyte salt can also be used.

Moreover, for the electrolyte, a solid electrolyte, anionic liquid composed of combination of a cation and an anion, symmetric glycol diether such as glymes, and chain sulfones can be used.

Further, in the above-mentioned embodiment, the organic compound was used for the positive electrode active material layer 2, but the organic compound may be used for the negative electrode active material layer.

Moreover, a shape of the battery is not particularly limited, and therefore the present invention can also be applied to a coin type battery, a cylindrical battery, a prismatic battery, a sheet-shaped battery, and the like. Also, a casing method is not also particularly limited, and a metal case, a molded resin, an aluminum laminate film or the like may be used for a casing.

Next, Examples of the present invention will be specifically described.

Besides, each of Examples shown below is just an example, and the present invention is not limited to Examples below.

### Example

### Preparation of Battery Cell

A rubeanic acid represented by the chemical formula (1a) was prepared.

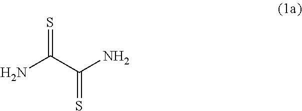

Then, 300 mg of the rubeanic acid, 600 mg of graphite powder as a conductive material, and 100 mg of polytetrafluoroethylene resin as a binder were respectively weighed, and these weighed materials were kneaded while being uniformly mixed as a whole to obtain a mixture.

Subsequently, the mixture was pressure-formed to prepare a sheet-shaped member having a thickness of about 150 μm. Then, the sheet-shaped member was dried at 70° C. for 1 hour in vacuum, and then punched out into a round shape with a diameter of 12 mm to prepare a positive electrode active material containing the rubeanic acid as a main component.

Further, polyvinylidene fluoride serving as a conductor material was dissolved in N-methyl-2-pyrrolidone as a solvent so as to be 10% by weight in concentration, and thereby, a conductor solution was prepared.

Then, the positive electrode active material was applied onto the positive electrode current collector to form a positive electrode active material layer, and the conductor solution was applied onto the positive electrode active material layer. Thereafter, the conductor solution was vacuum dried at 110° C. to coat the surface of the positive electrode active material layer with an ion conductor thin film having a thickness of 10 μm to obtain a positive electrode.

Next, LiPF₆ (electrolyte salt) was dissolved in a mixture of ethylene carbonate and diethyl carbonate as an organic solvent so that the molar concentration of the LiPF₆ was 1.0 mol/L to prepare an electrolyte solution. A mixing ratio between ethylene carbonate and diethyl carbonate was 30:70 in terms of % by volume.

Then, a separator having a thickness of 20 μm, which was made of a polypropylene porous film impregnated with the electrolyte solution, was laminated on the positive electrode, and further a negative electrode obtained by bonding lithium to a negative electrode current collector made of a copper foil was laminated on the separator to form a laminate.

Then, 0.2 mL of the electrolyte solution was added dropwise to the laminate to impregnate the laminate with the electrolyte solution.

Thereafter, a metallic spring was placed on the negative electrode current collector, and a negative electrode case was joined to a positive electrode case with a gasket arranged at its periphery, and these cases were externally sealed with a caulking machine, and thereby, a battery cell of Example was prepared.

Further, a battery cell of Comparative Example was prepared by the same method/procedure as in Example described above except for not coating a positive electrode active material layer with an ion conductor thin film.

Check of Operation of Battery Cell

The battery cells of Example and Comparative Example thus prepared were charged at a constant current of 0.1 mA for 3 hours, and thereafter, these battery cells were discharged at a constant current of 0.1 mA until a voltage is decreased to 1.5 V, and their charge and discharge characteristics were measured.

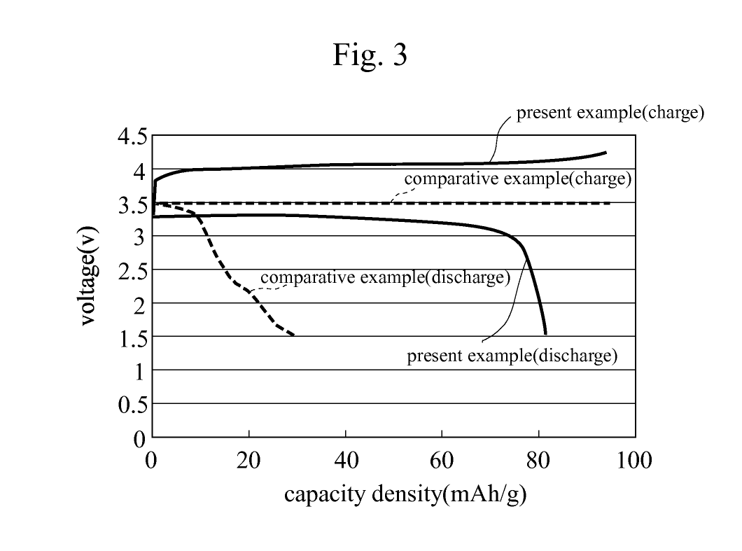

FIG. 3 shows the results of the measurement. The horizontal axis indicates a capacity density (mAh/g), the vertical axis indicates a voltage (V), a solid line indicates a charge-discharge curve of the present example and a broken line indicates a charge-discharge curve of the comparative example.

As is apparent from FIG. 3, while in the charge of the comparative example, a plateau of voltage was formed at 3.5 V and a capacity density was approx. 92 mAh/g, in the discharge, a plateau of voltage was not formed and the capacity density was rapidly dropped, and when discharge was ended, the voltage was 1.5 V, the capacity density was approx. 28 mAh/g, and the charge-discharge efficiency was as low as approx. 30%.

On the other hand, in the charge of the present example, a plateau of voltage was formed at 4.0 V and a capacity density was approx. 92 mAh/g, and also in the discharge, the plateau of voltage was formed at about 3.3 V and the capacity density was approx. 80 mAh/g at a voltage of 1.5 V at which discharge is ended, and the charge-discharge efficient was as excellent as 87%. The reason for this is thought to be that an rubeanic acid predominantly constituting the positive electrode active material layer is not dissolved in the electrolyte solution, and therefore lithium ions reach the surface and inside of the positive electrode active material layer with high efficiency of ion conduction to allow a desired charge-discharge reaction to occur between the lithium ions and the rubeanic acid because the surface of the positive electrode active material layer is coated with the ion conductor thin film.

A secondary battery, in which the charge-discharge efficiency is high even when using a multi-electron organic compound for the electrode active material and the reduction of a battery capacity can be suppressed even after repeating charge and discharge, is realized.

### REFERENCE SIGNS LIST

2 Positive electrode active material layer
3 Ion conductor thin film
4 Positive electrode (first electrode)
5 Negative electrode (second electrode)
9 Electrolyte solution

1. A secondary battery comprising:
a first electrode;
a second electrode; and
an electrolyte interposed between the first electrode and the second electrode, wherein
at least any one of the first electrode, the second electrode and the electrolyte contain lithium,
one of the first electrode and the second electrode includes an electrode active material layer containing, as a main component thereof, a multi-electron organic compound which has two or more electrons to be involved in a battery electrode reaction, and
an ion conductor film that selectively transmits lithium coats at least a surface of the electrode active material layer.

2. The secondary battery according to claim 1, wherein the ion conductor film contains at least one material selected from the group consisting of polyvinylidene fluoride, polymethacrylate and a polymer of tripropylene glycol diacrylate.

3. The secondary battery according to claim 1, wherein the ion conductor film has a thickness between 5-10 μm.

4. The secondary battery according to claim 1, wherein the organic compound contains, in a structural unit thereof, at least one selected from the group consisting of dithione compounds having a dithione structure, dione compounds having a dione structure, and diamine compounds having a diamine structure.

5. The secondary battery according to claim 4, wherein the dithione compound is represented by the general formula: 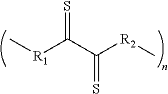
wherein n is an integer of 1 or more, R₁ and R₁ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group, and linking groups composed of combination of one or more thereof.

6. The secondary battery according to claim 5, wherein R₁ and R₂ are the same or are linked with each other to forma saturated or unsaturated cyclic structure.

7. The secondary battery according to claim 4, wherein the dithione compound is represented by the general formula: 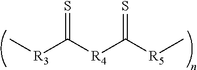
wherein n is an integer of 1 or more, R₃ and R₅ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group and linking groups composed of combination of one or more thereof, and R₄ is at least one of a substituted or unsubstituted alkylene group, a substituted or unsubstituted arylene group and a substituted or unsubstituted imino group.

8. The secondary battery according to claim 7, wherein R₃ and R₅ are the same or are linked with each other to forma saturated or unsaturated cyclic structure.

9. The secondary battery according to claim 7, wherein R₄ is the substituted or unsubstituted imino groups, and the imino groups are linked with each other.

10. The secondary battery according to claim 4, wherein the dione compound is represented by the general formula: 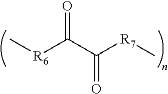
wherein n is an integer of 1 or more, R₆ and R₇ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group and linking groups composed of combination of one or more thereof.

11. The secondary battery according to claim 10, wherein R₆ and R₇ are the same or are linked with each other to forma saturated or unsaturated cyclic structure.

12. The secondary battery according to claim 4, wherein the dione compound is represented by the general formula: 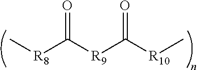
wherein n is an integer of 1 or more, R₈ and R₁₀ are any of a substituted or unsubstituted amino group, a substituted or unsubstituted imino group, a substituted or unsubstituted alkyl group, a substituted or unsubstituted alkylene group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted cyano group, a substituted or unsubstituted nitro group, a substituted or unsubstituted nitroso group, a substituted or unsubstituted carboxyl group, a substituted or unsubstituted alkoxycarbonyl group and linking groups composed of combination of one or more thereof, and R₉ is at least one of a substituted or unsubstituted alkylene group, a substituted or unsubstituted arylene group and a substituted or unsubstituted imino group.

13. The secondary battery according to claim 12, wherein R₈ and R₁₀ are the same or are linked with each other to form a saturated or unsaturated cyclic structure.

14. The secondary battery according to claim 12, wherein R₉ is the substituted or unsubstituted imino groups, and the imino groups are linked with each other.

15. The secondary battery according to claim 4, wherein the diamine compound is represented by the general formula: 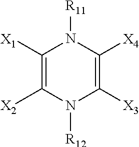
wherein R₁₁ and R₁₂ are any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amino group, a substituted or unsubstituted amide group, a substituted or unsubstituted sulfone group, a substituted or unsubstituted thiosulfonyl group, a substituted or unsubstituted sulfonamide group, a substituted or unsubstituted imino group, a substituted or unsubstituted azo group, and linking groups composed of combination of one or more thereof; and X₁ to X₄ represent at least one of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted aryl group, a substituted or unsubstituted aromatic heterocyclic group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group and a substituted or unsubstituted acyloxy group.

16. The secondary battery according to claim 15, wherein R₁₁ and R₁₂ form a cyclic structure.

17. The secondary battery according to claim 1, wherein an electrode active material of the electrode active material layer is contained in anyone of a reaction starting material, a reaction product and an intermediate product in at least a discharge reaction of the battery electrode reaction.

18. A method for producing a secondary battery, the method comprising:
providing a first electrode and a second electrode, wherein one of the first electrode and the second electrode includes an electrode active material layer containing a multi-electron organic compound as a main component thereof;
interposing an electrolyte between the first electrode and the second electrode; and
coating at least a surface of the electrode active material layer with an ion conductor film that selectively transmits lithium ions.

19. The method for producing a secondary battery according to claim 18, wherein an electrode active material of the electrode active material layer is contained in any one of a reaction starting material, a reaction product and an intermediate product in at least a discharge reaction of a battery electrode reaction.
